(19) United States
(12) Patent Application Publication
(10) Pub. No.: US 2019/0073820 A1
(43) Pub. Date: Mar. 7, 2019

(54) Ray Tracing System for Optical Headsets

(71) Applicant: Mira Labs, Inc., Los Angeles, CA (US)

(72) Inventor: Christine Barron, Los Angeles, CA (US)

(21) Appl. No.: 16/112,568

(22) Filed: Aug. 24, 2018

Related U.S. Application Data
(60) Provisional application No. 62/553,692, filed on Sep. 1, 2017.
(60) Provisional application No. 62/591,070, filed on Nov. 27, 2017.

(51) Int. Cl. G06T 15/06; G06T 15/50; G06T 7/73; G06T 5/00; G02B 27/01

(52) U.S. Cl. CPC G06T 15/06; G06T 15/506; G06T 7/73; G06T 5/006; G06T 19/006; G02B 27/0172; G06T 2207/30201; G06T 2200/24; G02B 27/0179

(57) ABSTRACT

Exemplary embodiments include an optical method of accurately locating a real world object and relating the location to a virtual location of the system (such as a screen location, pixel location, camera location, or combinations thereof) and/or visa versa. Exemplary embodiments of the method may be used for counter-distortion techniques to more accurately display virtual objects, to calibrate a system to an individual user and/or use configuration, eye tracking, and combinations thereof.

### PRIORITY

This application claims priority to U.S. Application No. 62/553,692, filed Sep. 1, 2017; and U.S. Application No. 62/591,070, filed Nov. 27, 2017, each of which is incorporated by reference in its entirety into this application.

### BACKGROUND

Head Mounted Displays (HMDs) produce images intended to be viewed by a single person in a fixed position related to the display. HMDs may be used for Virtual Reality (VR) or Augmented Reality (AR) experiences. The HMD of a virtual reality experience immerses the user's entire field of vision and provides no image of the outside world. The HMD of an augmented reality experience renders virtual, or pre-recorded images superimposed on top of the outside world.

U.S. application Ser. No. 15/944,711, filed Apr. 3, 2018, co-owned by Applicant, describe exemplary augmented reality systems in which a planar screen, such as that from a mobile device or mobile phone, is used to generate virtual objects in a user's field of view by reflecting the screen display on an optical element in front of the user's eyes. FIG. 1 corresponds to FIG. 1 of the cited application and FIG. 2 corresponds to FIG. 3 of the cited application. FIG. 1 illustrates an exemplary headset for producing an augmented reality environment by reflecting images from a display off an optical element and into the user's eye to overlay virtual objects within a physical field of view. The exemplary headset 10 of FIG. 1 includes a frame 12 for supporting the mobile device having a mobile device 18 with a display 22, and optical element 14, and a mounting system 16 to attach the display and optical element to the user. FIG. 2 illustrates exemplary light paths from the display screen 22, off the optical element 14, and into a user's eye.

The curvature of the optical element and the positioning of the optical element in relation to the position of the display screen determine many of the visual characteristics of the combined image seen by a wearer of the augmented reality headset, including, but not limited to, clarity, aberrations, field of view, and focal distance. The curvature of the optical element and its positioning may be designed in concert to optimize visual characteristics. The design (including position, orientation, and curvature) may be used to determine how a virtual object is reflected and thereby perceived by a user. However, such design typically makes presumptions on the location of the user's eye, the dimensions and attributes of the display screen, and alignment to the optical element. In reality, design tolerances, wear, and other factors contribute to a range of alignments, shapes, orientations, and positions of the respective components relative to each other. Therefore, the augmented reality system may display distorted virtual objects or contain aberrations or visual effects to a wearer.

An exemplary method for anti-distortion within virtual reality applications include correcting for barrel distortion. Barrel distortion corrects for lens effects in which image magnification decreases with distance from the optical axis. Software may be used to correct the barrel distortion. For example, for the radial and tangential distortion, the Brown-Conrady model may be used

### SUMMARY

Exemplary embodiments include an optical method of accurately locating a real world object and relating the location to a virtual location of the system (such as a screen location, pixel location, camera location, or combinations thereof) and/or visa versa.

In an exemplary embodiment, an image of the real world object is received by the front facing camera. The system is then configured to receive an input to identify the object or automatically detect the object in the image through object recognition techniques. The system is then configured to accurately determine a real world location based on a ray tracing model of the object. The ray tracing model can include the effects of the lens present in the AR or VR system. Exemplary embodiments may use counter-distortion techniques to more accurately locate the real world object.

Exemplary embodiments of the object location method may be used to calibrate the system or dynamically adjust the system for individual use and/or in use configurations.

Exemplary embodiments of the object location method may be used to track objects.

Exemplary embodiments of the object location method may be used alone or in conjunction with creation of counter-distortion methods described here or otherwise known in the art. For example, objection detection and location may be used to detect and locate the real world position of a user's eye(s). Such location may be used for gaze tracking, such as to determine and track where a user is looking. Such location may be used for eye location for system configuration. In an exemplary embodiment, eye location may be used for dynamically determining a user's interpupilary distance and calibrating a VR/AR system.

Exemplary embodiments include an optical ray tracing method and system for dynamically modelling reflections from an optical element. The modelling may be based on system parameters such as, for example, a screen location, an optical component location, a user's eye position, and combinations thereof.

The modelling may be used to generate a display element based on the ray trace in real time. The display element may be, for example, a virtual object to be overlaid in an augmented reality system.

The modelling may be used to configure the system. The modelling may therefore also include receiving an image reflected off of the optical element; identifying a pupil location on the image; using the ray trace to determine a world space location of the pupil identified on the image. The world space location of the pupil may then be used to define a system parameter and update a counter distortion method used to generate a display object to be reflected off of the optical element. The counter distortion method may use an updated ray tracing to generate a display image based on a desired perceived location of the virtual object, the system parameters including the screen location, the optical component location, and an eye location determined from the world space location of the pupil.

### DRAWINGS

FIG. 1 illustrates an exemplary side profile view of an exemplary headset system according to embodiments described herein positioned on a user's head.

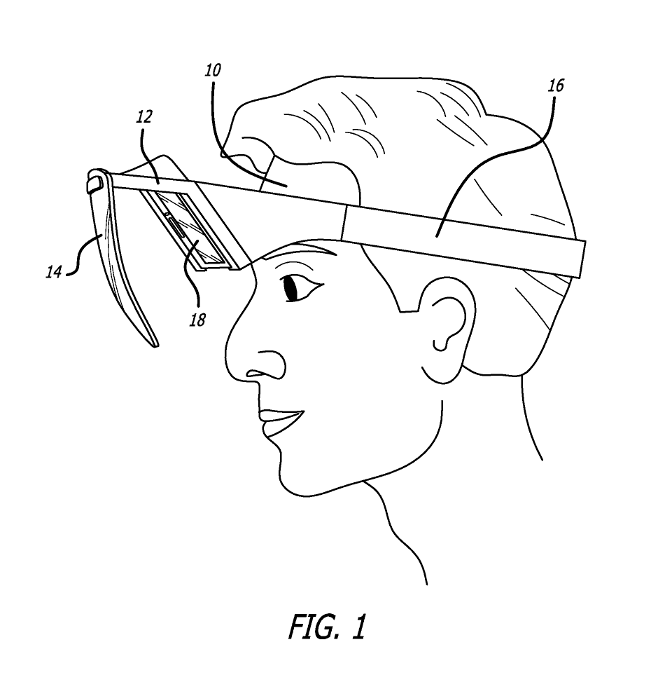

FIG. 2 illustrates an exemplary light propagation from a display screen to the user's eye using an optical element according to embodiments described herein.

FIG. 3 illustrates an exemplary system in which the attributes of exemplary relevant features of the system are displayed.

FIG. 4 illustrates an exemplary user interface for entering variables relevant to generating a ray trace for the system.

FIG. 5 illustrates an exemplary embodiment of a visual representation of constraints and variable definitions for use in an exemplary ray tracing algorithm according to embodiments described herein.

FIG. 6 illustrates an exemplary image returned to a camera of a mobile device inserted into an augmented reality head mounted display system according to embodiments described herein.

FIG. 7 is an exemplary visual illustration of a ray trace according to embodiments described herein.

FIGS. 8A and 8B illustrate exemplary images taken according to embodiments described herein.

FIG. 9 illustrates an exemplary embodiment ray tracing that may be used in an exemplary dynamic counter distortion and rendering method according to embodiments described herein.

FIG. 10 illustrates an exemplary counter distortion mapping according to embodiments described herein.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Exemplary embodiments described herein include a counter-distortion model that operates on a ray tracing behaviour that is dynamic and adjustable to account for variations between users in real time at the time the user engages the headset for use.

Exemplary embodiments include an optical ray tracing innovation to create counter-distortion models. Exemplary embodiments may be used to adjust variables such as screen size, phone positioning, interpupilary distance, eye position, and any combination thereof dynamically at the time of use. As such, exemplary embodiments may be used to greatly improve the ability to generate counter-distortion models for many different phone sizes or to accommodate new hardware designs dynamically without going through the cumbersome process of generating a counter-distortion equation in third-party software for each design change.

Exemplary embodiments include an optical detection system to determine a location of the user's eye. Exemplary embodiments may be used to determine the location of a user's pupillary distance for calibrating or setting parameters of an AR or VR system. Exemplary embodiments may be used for eye-tracking. Exemplary embodiments of eye tracking methods may be used to interpret where the user is looking. Exemplary embodiments may be used to enhance or improve the ray tracing models to improve or correct the counter-distortion models.

Although embodiments of the invention may be described and illustrated herein in terms of a specific augmented reality headset system, it should be understood that embodiments of this invention are not so limited, but are additionally applicable to different virtually rendered objects such as different augmented reality and virtual reality systems. Exemplary embodiments of the ray tracing model include methods for determining a position of the headset relative to the user, determining a position of a user's eye relative to the headset, rendering virtual objects to be displayed on a mobile device and reflected to the user for augmenting their physical perception, and any combination thereof. Exemplary embodiments do not necessarily include all features described herein, but may instead take advantage of any combination of features and remain within the scope of the instant disclosure.

Exemplary embodiments described herein include a real time, optical ray tracing method for modeling reflections of or off of a concave, reflective (semi-reflective, or mirrored) lens (optical element). Reflective is intended herein to be encompassing of any interface that reflects at least some of the light. Therefore, a lens may be reflective even if some light is permitted to traverse (pass) the lens.

Exemplary embodiments described herein include an augmented reality system, software and hardware configured to retrieve variable attributes of the system configuration. The system may be configured to use the variable attributes of the system configuration to determine a ray trace based on the variable attributes in real time. From the ray trace and/or the variable attributes, the system is configured to create a counter-distortion map in real time and dynamically in response to the variable attribute. Exemplary embodiments may also or alternatively be used to determine a variable attribute in real time. The variable attribute may then be used in real time to update the counter-distortion map and reduce the distortion created in the system by the specific details of the real-time use of the system and the user. A counter-distortion map is not intended to be limiting of any specific translation scheme. For example, an counter-distortion map may use polynomial approximations, data point tables, or other schemes for translating a desired perceived location of a virtual object in a user's field of view to a display location on a display screen to be reflected off a lens into the user's eye and superimposed into the user's field of view, and visa-versa.

Exemplary embodiments described herein use an optical ray tracing method and system for dynamically modeling reflections of a concave lens to determine, generate, or define a virtual object for projection to a user. In other words, exemplary embodiments may be used to create a counter-distortion system to dynamically account for variable attributes such as created by the device (screen position, size, etc.), the user (eye position, interpupilary distance, etc.), or the system (the relative positions and orientations of system components including lens, display, and user, etc.), and any combination thereof.

In an exemplary embodiment, the system is configured to receive variables relevant to determining and calculating a ray trace of the headset. For example, in the augmented reality systems described by Applicant's co-pending headset applications (U.S. application Ser. No. 15/944,711, filed Apr. 3, 2018, and incorporated by reference in its entirety herein), the lens shape and size, display shape and size, and relative positions of the lens, display, and user's eye may be relevant. In an exemplary embodiment, the system is configured to receive variables such as eye position, lens position, lens radius of curvature, lens curvature equation, lens tilt, display position, display tilt, or other offsets, parameters, or information to define the attributes of an augmented reality or virtual reality system, and any combination thereof.

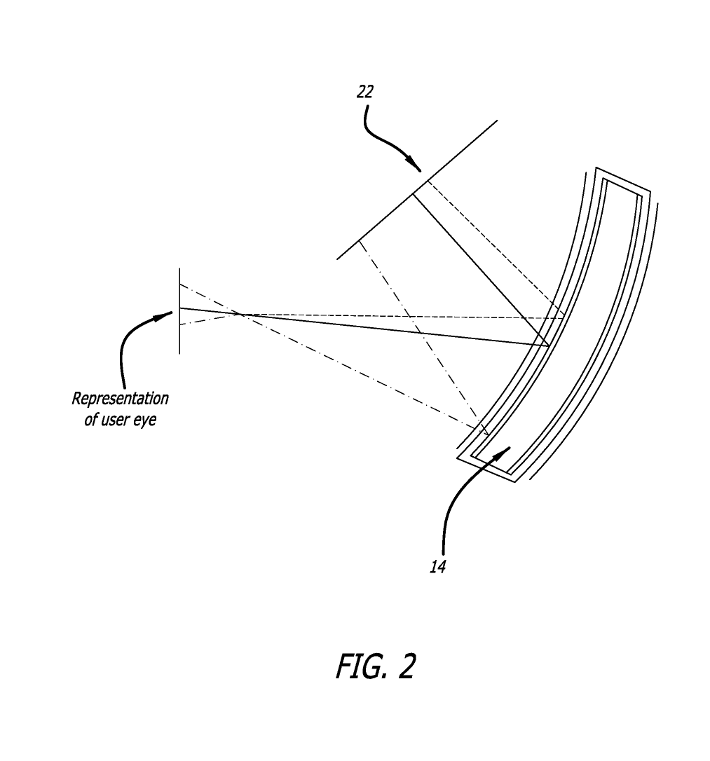

In determining how to display a virtual object, exemplary embodiments of a system may use a generalized ray-tracing algorithm based on the theoretical position of the display, the optical element, and the user's eye. FIG. 2 represents such a theoretical ray tracing. Augmented reality systems may include separate or integrated programs for performing generalized ray-tracing. Such programs may generate sets of data tables mapping input angles to output display coordinates. Therefore, whenever a programmer wants to display a virtual object in a specified location to a user, the mapping is used to translate the desired location to the position and dimensions of the displayed object on the screen. Specifically, the mapping may be performed by approximating the ray traces with a polynomial equation to approximate and represent the mapping. The equation may be used to create a counter-distortion mesh. Exemplary embodiments of the polynomial approximation may incorporate the position of the user's eye into the model. The physical attributes of users vary as well as the preferred location of wearing the headset. These attributes may be entered into the system and remain static between users and different users; may be entered before a use of the system, such as at a configuration stage, and remain static until changed by a user or the system; may be determined on the fly or in real time before a rendering or periodically during the virtual object creation and rendering process; at an initiation period before each use of the system, such as at a power up or when a new application or rendering session is initiated; or combinations thereof. Exemplary embodiments of an anti-distortion model incorporating a polynomial approximation may calculate the approximation and define a mapping or look up table of locations or modifications, may use the polynomial approximation dynamically, in real time to adjust or modify the created output to account for the distortion, and combinations thereof.

As compared to the conventional Brown-Conrady Radial and Tangential models to correct for lens distortion, exemplary embodiments described herein using machine learning, regression, polynomial approximations, and combinations thereof provides for less error in the approximation. Exemplary virtual reality and optical headset applications may also produce asymmetric distortion that does not fit the radial model of the conventional methods. The asymmetric distortion may originate from the position of the display, the position of the center of the lens sphere, the relative locations of the lens center, the display, and the user's eye, and combinations thereof. Exemplary embodiments described herein may provide for symmetric and/or asymmetric anti-distortion modeling.

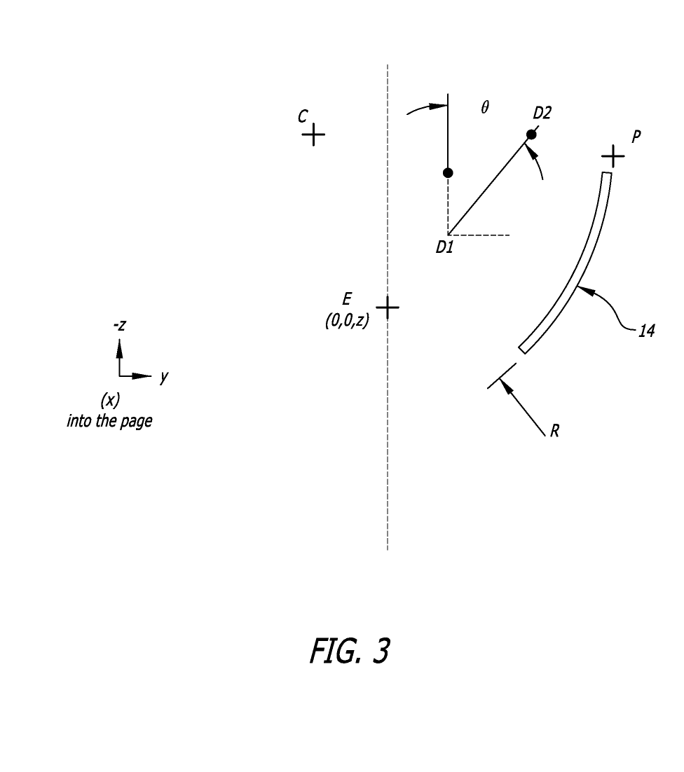

FIG. 3 illustrates an exemplary system in which the attributes of exemplary relevant features of the system are displayed. As shown, the eye of a user E is set at the origin of a reference system. The display screen, identified as the line between D1 and D2 defines a height of the screen and with the angle, defines an orientation of the screen. The optical element includes a radius and position by identifying its center of curvature. These attributes can be used to define the system configuration that impacts the light propagation from the screen to the user, and thereby the perceived virtual object overlaid on the physical environment. The reference system relative to the eye is used as an example only, any reference and/or coordinate system may be used to define relative positions of the eye (or desired focal or viewing locations), screen, and optical element to determine a ray trace.

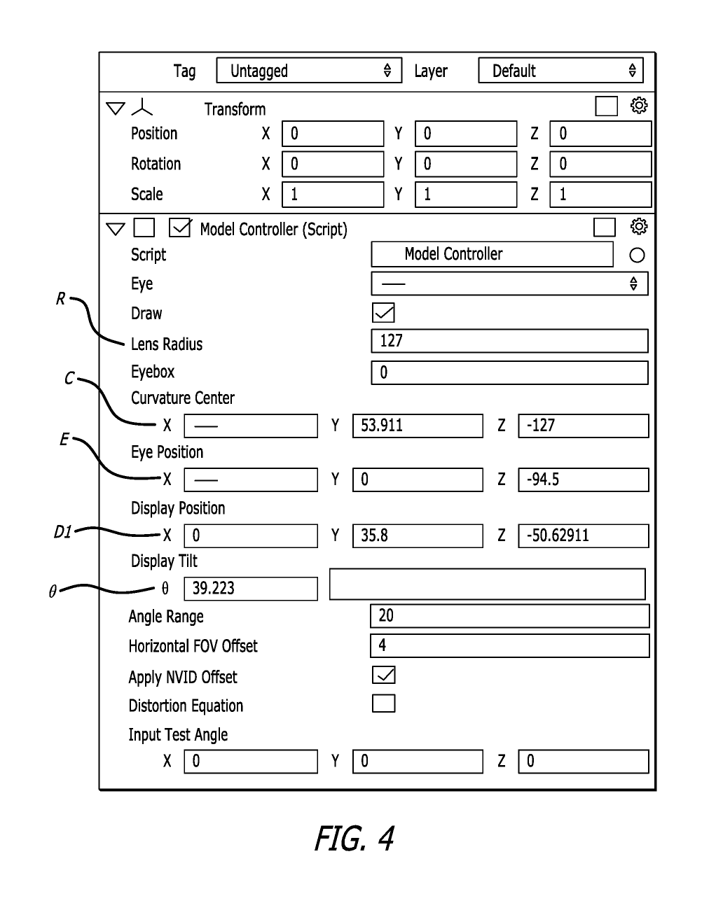

FIG. 4 illustrates an exemplary user interface for entering variables relevant to generating a ray trace for the system. The exemplary variables may be any variable combination that may be entered by a user and/or detected by the system and used to determine a shape, size, position, and/or orientation of a displayed object on a screen to create a projected virtual object within a field of view of the user. For example, the variable attributes may include a radius R of the optical element, and center of curvature C of the optical element, the eye position E of the user, the position of the bottom edge (or any reference point) of a display screen D1, an angle of tilt θ of the display screen.

In an exemplary embodiment, the system may be programmed with data or may be configured to receive data for a number of variables such as a radius of curvature of the optical element, a display size of a screen and/or a size of a mobile device supporting a display (including a screen diagonal size (in length and/or pixels), screen dimensions (in length and/or pixels), pixel size, aspect ratio), and an eye model (including, for example, paraxial, pupil diameter, focal length), position of optical element (positional and/or rotational about an axis). The system may be programmed with one or more constraints or other inputs. For example, the system may be configured that the left and right geometries are mirror images of each other, the optical element lower and upper inside edges with respect to the pupil minimum corresponds to the inter-pupillary distance divided by 2, eye relief on an axis extending outward in front of the eye from a minimum distance of 12.0 mm without an outward maximum (i.e. infinite), and the display position bottom edge with respect to the pupil position in the negative z direction is fixed at 13-15 mm or approximately 13.9 mm and in the y direction is fixed at 23-26 mm or 24.5 mm. The system may also be programmed with data or may be configured to receive data for a number of optical design parameters, such as, for example, a design wavelength of 550 nm, virtual image distance from 450 mm to 770 mm with a nominal range of approximately 610 mm, an inter-pupillary range of between 52.0 mm to 78.0 mm and mean of 63.4 mm, and a field of view horizontal offset (Az) of −atan(IPD/(2*NVID)), a field of view horizontal offset (El) of −4 degrees fixed, and vertical offset distance of 152.4 mm, where IPD is the inter-pupillary distance and NVID is the virtual image distance, and the fields Az and El are fields and weights used for optimization of solutions.

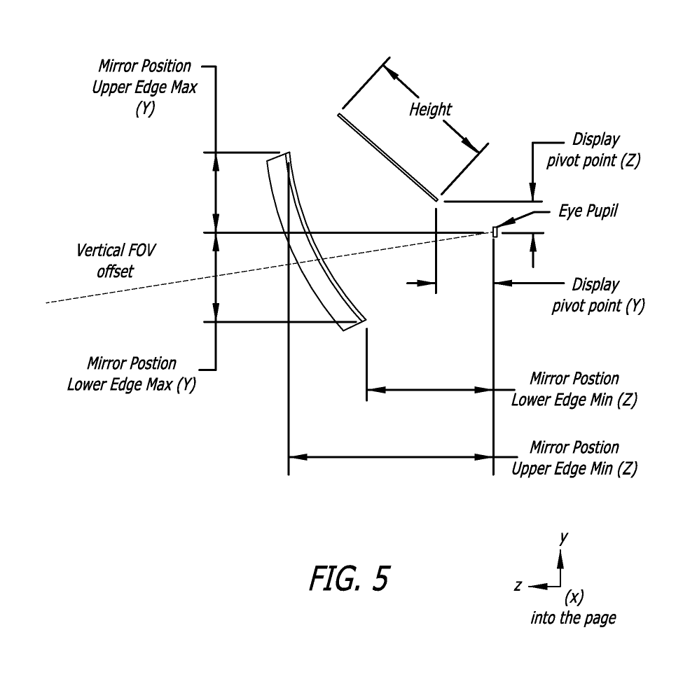

FIG. 5 illustrates an exemplary embodiment of a visual representation of constraints and variable definitions for use in an exemplary ray tracing algorithm according to embodiments described herein. Optical design parameters may include the design wavelength. Since the optical element is reflective, an exemplary embodiment may use parameters assuming monochromatic light, such as at a wavelength between 500-750 nm, or 500-600 nm, such as a wavelength of 500 nm. Other optical design parameters may include a mirror position including upper and lower edge minimum and maximum positions in an orthogonal reference system, display width, position of lower edge of display in the orthogonal reference system, rotation of the display, rotation of the eye pupil or vertical field of view offset compared to the reflector, position of the user's eye.

If actual, measured, or preferred variable values are not known or determinable to a specific configuration and/or user, then weighted ranges may be used to blend or approximate a display system for adoption across different users. Exemplary embodiments described herein may be used to minimize use of ranges and blending, but may still take advantage of such generalities for select attributes and variables. In order to optimize the system over a range of focal points and design parameters, the system may set a nominal, average, median, or other value as a target parameter but permit a range therefrom. The range around the nominal, average, median, or other value may be weighted such that its impact on the system design is reduced, and the system is designed for around a primary set of design parameters but accommodates or is optimized over a range. Parameters that may be optimized over a range include, for example, virtual image distance and/or interpupilary distance. For example, a virtual image distance (NVID) may be approximately 24 inches having a 100% weight with a range of 18 inches with the outside points of the range (6 inches and 42 inches) being weighted at 0%. Interpupilary ranges may include a mean at 24.96 inches having a 100% corresponding weight. The IPD ranges and associated weights may be, for example, a minimum IPD of 20.5 inches weighted at 0%, a second standard deviation of 21.9 inches weighted at 30%, a first standard deviation of 23.4 inches weighted at 75%, a first standard deviation of 26.5 inches weighted at 50%, a second standard deviation of 28 inches weighted at 20% and a maximum IPD of 30.7 inches weighted at 0%. Focusing fields and offsets may also be included as system parameters. For example, a field of view horizontal offset (Az_offest) may equal atan (IPD/(2*NVID)); a field of view horizontal offset (El_offset) may equal a fixed angle, such as, for example, an angle between 0 and 10 degrees, such as 4 degrees. A virtual offset distance dY may be a fixed value of between 0 and 5 inches such as 1.2 inches. Exemplary embodiments described herein may be used, for example, to measure the interpupilary distance and set an actual value associated with a user in real time that does not require the weighted average or blending of a range of interpupilary distances and thereby improvement the appearance and immersive effect of the display virtual objects.

Exemplary embodiments may be used to make real time adjustments to one or more than one variable in order to create an individualized model for a user. Exemplary embodiments may be used to directly drive a counter-distortion model by real-time generated ray tracings based on dynamically entered or real-time entered variables rather than being precomputed or based entirely on static or pre-defined attributes.

Exemplary embodiments may permit a user to enter attributes, may pre-define attributes at the time of coding, or may permit the system to obtain attributes through one or more hardware or software recognized inputs. The system may be configured to recognize hardware components or model types and define one or more attributes for use by or to suggest as an input to the system. For example, the system may automatically recognize the mobile device model. The mobile device model may therefore define general attributes such as screen size. The system may be configured to retrieve this information from the hardware, firm ware, or stored software data, and generate the appropriate general attributes and/or variable attributes to be used and/or suggested to be used to generate the ray tracing model.

In an exemplary embodiment, the system may be configured to retrieve and determine attributes based on one or more inputs, sensors, or other retrieved information from the system. For example, the system may be configured to receive an image from a camera of the mobile device and determine one or more attributes, such as lens dimension, lens configuration, eye position, inter pupillary distance, other attributes, and any combination thereof.

In an exemplary embodiment, the system may use a camera or other sensor of the system to obtain, calculate, determine or otherwise define an attribute. For an exemplary system such as an augmented reality system where the mobile device is inserted into a headset where a semi-reflective/transparent lens is used to reflect a displayed object into the user's field of view, the front facing camera may be used to retrieve images reflected from the lens system. The reflected images may be used to determine an attribute such as attributes of a user (eye position, inter-pupilary distance, etc.). Other attributes may also be determined such as lens configuration, orientation, position, etc.

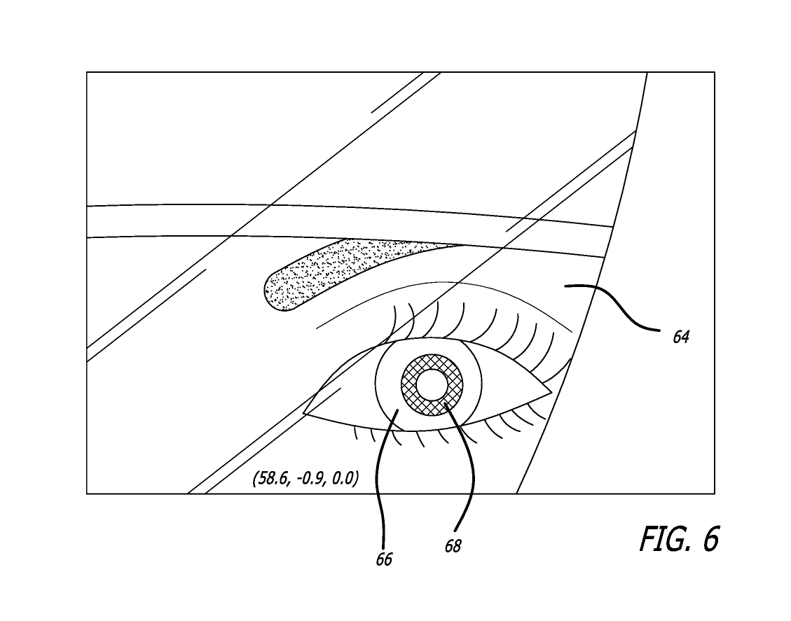

FIG. 6 illustrates an exemplary image returned to a camera of a mobile device inserted into an augmented reality head mounted display system according to embodiments described herein. Methods according to exemplary embodiments described herein may be applicable to other head mounted display systems and are not limited hereby. As shown in FIG. 6, the returned image captures part of the optical element 64. The reflection off of the optical element 64 includes an image of a portion of the user's face, including an eye 66. Exemplary embodiments are configured to retrieve an image of at least a portion of the optical element capturing a portion of the user's face including one or both eyes.

Exemplary embodiments may then determine a position of the user's eye in the captured image. The system may, for example, use image recognition software to detect and determine a position of the user's eye, permit a user to select or identify the position of the user's eye on an displayed image, permit a user to confirm an suggested identification using combinations of image recognition and user input, and combinations thereof. As seen in FIG. 6, the system may superimpose a suggested location of a user's pupil on the captured image. The superimposed suggested location and/or captured image including a user's eye may be displayed virtually through the augmented reality headset, displayed on a display in communication with the headset, and combinations thereof.

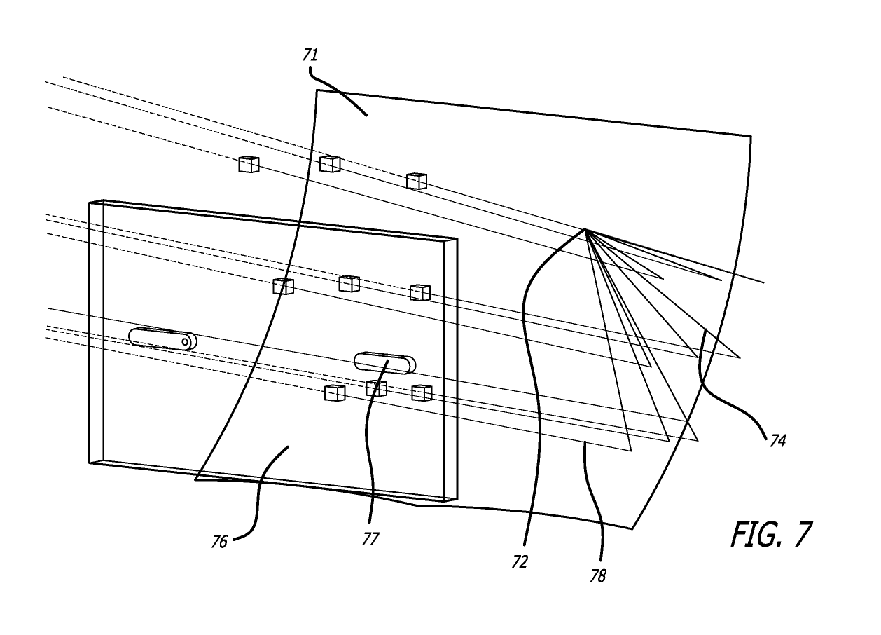

FIG. 7 is an exemplary visual illustration of a ray trace according to embodiments described herein. As shown, the system knows the position, orientation, and variable attributes describing the optical element 71. The system also knows or can determine to relative position and orientation of the camera location 72 on an inserted mobile device within the headset relative to the optical element. The parameters of the optical element and camera location are defined by the headset itself and the inserted mobile device. The ray tracing can then generate a plurality of traces 74 that can correlate the location of objects captured on the image reflected from the optical element. The system may assume a position of the user's face and define a plane 76 in which the reflective image may have from.

From the determination of the pupil of the user on the captured image, the system can determine a ray trace 78 that can define a position of the user's pupil 77 in real space relative to the optical element 71 and camera 72. The system may determine the position of the eye by defining orthogonal or other coordinates associated with pixels of the captured image. The indication or determination of the pupil location within the capture image can therefore translate to a given coordinate within the coordinate system. The third dimensional coordinate may be assumed or entered such as by defining the plane in which the face is likely to reside relative to the headset, camera, and/or optical element. The third dimensional coordinate may also be calculated or determined by the system with the entry of an additional data point, such as by using a focus feature of the camera, having the user enter a defined parameter, taking and/or receiving an additional data entry, and combinations thereof.

Once the system has determined a likely position of the user's eye, the system may use that information as a data entry into one or more of the variables described herein for customizing the design constraints used to generate the virtual images for display to a user. For example, once the position of a user's eye is determined, the system may determine an interpupilary distance that is then used within the algorithm, such that based on a second ray tracing, to determine the position of a virtual object on a mobile device display to create the overlay of the image within a user's field of view in a desired position.

The system may use the position of the user's eye and/or one or more facial features captured from the reflected image to determine one or more parameters for generating the counter-distortion model tailored to the individual user. For example, as described herein, the system may determine an interpupilary distance of a user. As another example, the system may determine the relative vertical offset of the headset. Any user may have a preferred location of the headset strap on a user's head. For example, the user may wear the headset further up toward the top of their head, or lower down, toward their eyes. The position of the headset on the user's head may offset the displayed images as the optical element would be moved vertically relative to the user's eyes. The system may therefore use the vertical position of the user's eyes to determine a vertical offset of the headset created by the position of the headset on the user's head.

The system may therefore use variable and general attributes including a relative position of the image capture point, the optical element, and a plane in which the user's eye is expected to be positioned, as well as the reflection on a lens system to determine a user's inter-pupillary distance without having to use a separate object or object of known dimension. First, the system may retrieve as an input a reflected image from the lens system with a camera of a mobile device. The camera may be a front facing camera directed toward the lens system. The reflected image may include an image of one or both eyes of the user. Using the race tracing obtained from the variable and general attributes, the system may determine the world-space position of the object generating the reflected image (i.e., the user's eye). The variable and general attributes may include a relative location of the image capture device, the lens system position/orientation/attributes, a plane in which the user's eye is expected to be positioned, and combinations thereof.

Using a ray tracing model, the reflections captured as an image by the front facing camera of the mobile device, may be mapped to world-space positions. In an exemplary embodiment, exemplary rays originating from the position and rotation of the front camera may be used to determine the position of the user's eye or portions thereof. The information of the relative position of the front facing camera may be another attribute entered or coded into the system as described herein (such as a general or variable attribute that is automatically detected, entered, hard-coded, or otherwise obtained by or entered into the system). After applying radial counter distortion to the image (to counter the distortion caused by the lens in the front-facing camera), the system may calculate where the user's eye position occurs. In an exemplary embodiment, the user may be presented with the image captured by the front facing camera so that the user may identify, such as by tapping, touching, tracing, or otherwise indicating on the image where the user's eye (or portion thereof—such as a pupil) occurs on the image. Exemplary embodiments may also use image processing and recognition to automatically select a position of the user's eye. Exemplary embodiments may also use combinations of automatic detection and user inputs. From the identification of the eye, the system may convert the pixel coordinate into an approximate world-space coordinate. In an exemplary embodiment, the system may determine the approximate world-space coordinate of both of the user's pupils. From these world-space coordinates, the system may determine an approximate user's inter-pupillary distance as the straight line distance between the approximate world-space coordinate associated with each eye.

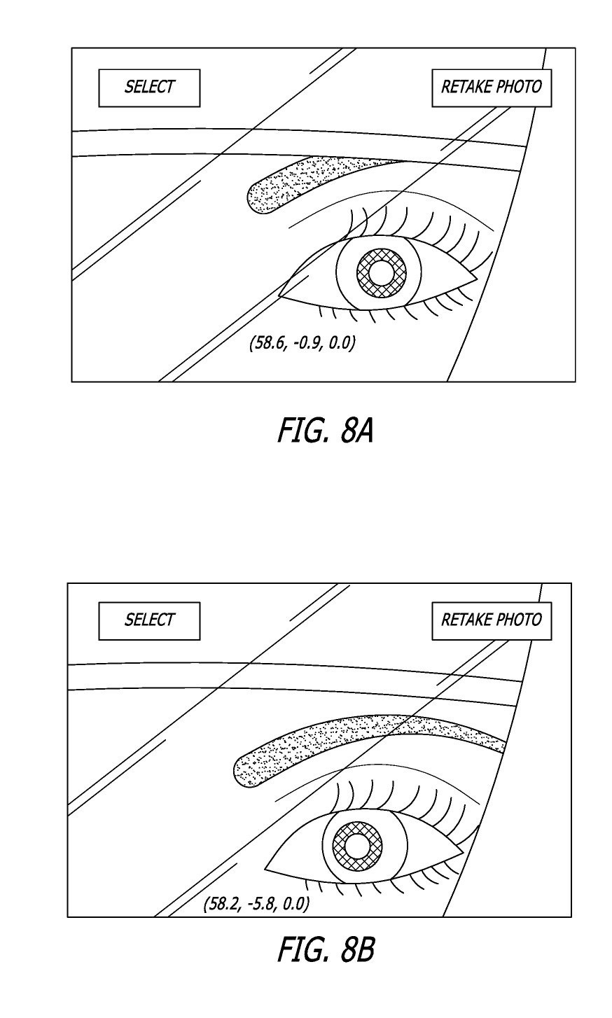

In an exemplary embodiment, the system may be configured to capture an image reflected from the lens system and perform the analysis according to embodiments described herein. The system may then present the results to the user and permit the user to confirm or reject the conclusions of the system's analysis. For example, the system may retrieve an image from a camera of the mobile device, identify a location of a user's pupil, use the ray trace and/or counter-distortion algorithms to determine a position of the user's eye in world space. The system may determine an interpupilary distance, vertical offset, or any combination of variables or attributes to define the system dynamically with respect to the individual user and/or specific use of the system for an individual user. The system may thereafter display the results to the user. For example, the system may display the captured image, the indication of the determined user's pupil, and the pupil position, interpupilary distance, and/or vertical offset as seen in FIG. 8A or 8B. The system may then ask the user to confirm, reject, retake the image, or provide user input to confirm, update, or restart the process.

FIGS. 8A and 8B illustrate exemplary images taken according to embodiments described herein. FIG. 8A illustrates a configuration in which the headset is worn higher on the head than the user of FIG. 8B. The system according to embodiments described herein using the exemplary captured images determined the interpupilary distance (first lower, left number, 58.2/58.6) and a relative height offset at which the user is wearing the headset (second, lower, left number −0.9 and −5.8).

Because the calculation is being performed by a 3-dimensional model, the inter-pupillary distance (IPD) calibrator results in accurate IPD measurement, regardless of how high or low the headset is worn on the head. In the photos provided herein, the first number on the left (58.2 and 58.6) is the calculated IPD, and the second value (−0.9 and −5.8) is the approximate height at which the user is wearing the headset.

In an exemplary embodiment, before the method provided herein is performed, the system may first position the user's eyes in a desired location/orientation. For example, the user may be prompted or encouraged to look at a specific location on the horizon so that the measurements are based on a desired eye orientation. In an exemplary embodiment, the system may be configured in software to guide the user to look at a point projected into the distance. The system may therefore create an image, such as a spot, x, letter, figure, icon, instruction, etc. to be displayed on the mobile device and reflected off of the optical elements and overlaid in the user's field of view to define a point in which the user should focus. The system may thereafter perform the steps described herein including, but not limited to, taking a photo, capturing the eye reflection, determining the pixel that roughly represents the center of the eye (either automatically or as a user entered input, such as through the touch screen or UI/AR/VR interface), performing the ray trace for that point, and calculating a position. Exemplary embodiments may include software to then recalculate the distortion (such as by modifying the variable attributes and recalculating the ray trace map based on the modified variable attribute) to reflect exactly how the user is wearing the headset, ensuring that the stereoscopic rendering is as calibrated as possible to the individual user.

The data obtained as described herein may be used with machine learning based on real-time object detection, which could eliminate the need for the user to manually detect their eye in the reflected image, and enable automated eye tracking. In an exemplary embodiment, the user's IPD is known (either as a direct input or determined based on embodiments described herein), the reflection ray tracer would be used to convert the pixel position associated with the pupil of the user's eye to a 3-dimensional rotation and corresponding ray, which allows the system to approximate the simulated depth or direction at which the user is looking.

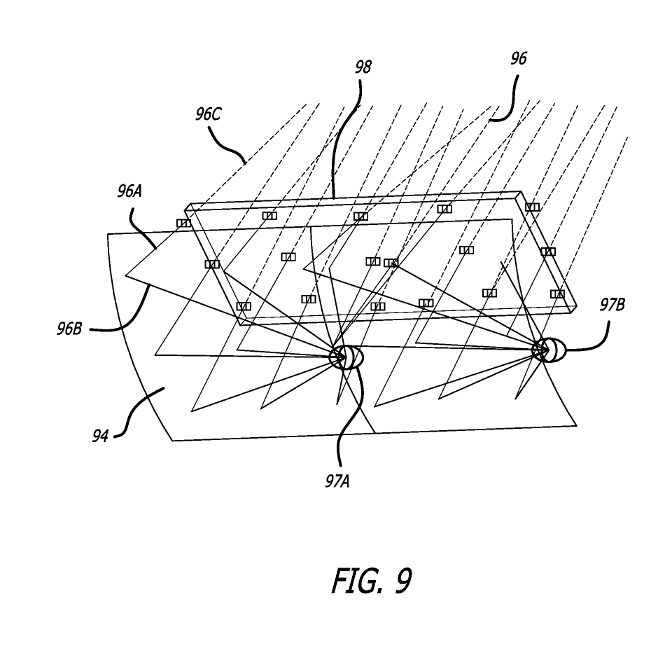

FIG. 9 illustrates an exemplary embodiment ray tracing that may be used in an exemplary dynamic counter distortion and rendering method according to embodiments described herein. In an exemplary embodiment, system parameters may be defined by general and/or variable attributes. For example, the position and/or orientation of the display 98; position, shape, and/or orientation of the optical element 94, and position of the user's eye 97A and 97B may be variables within the system. The variables may be entered or determined according to embodiments described herein.

From the entered information, the system may be configured to generate a ray trace based on the variables. In an exemplary embodiment, the system is configured with general attributes of an augmented reality or general reality headset, and defined by one or more variable attributes. Such general attributes and variable attributes are used to calculate and generate a ray tracing corresponding to a unique system configuration defined by a combination of the general attributes and specific attributes.

FIG. 9 illustrates an exemplary ray tracing generated from the variable attributes entered in FIG. 4 and corresponding to the general attributes of an augmented reality system as described the Applicant's co-pending augmented reality systems, U.S. application Ser. No. 15/944,711, filed Apr. 3, 2018. For example, the general attributes may include elements such data defining the lens such as constant radius dual lens system without a gap between lens positioned angularly relative to a flat display screen in which the user's eye is positioned below the display screen. Therefore, general attributes include the constant curvature lens configuration, a dimensional size of the lens (such as height and width), a planar definition of the display/projection creating the virtual object, and a coordinate system for defining a relative position of the lens, the user's eye, and the display. Variable attributes may include relative translational and/or rotational orientations of the lens, display, and eye positions. Variable attributes may be defined by the general attributes, such as the coordinate system.

As shown in FIG. 9, the system may determine where and how to create a displayed image on a flat display screen to reflect off of an optical element 94 and into the user's eye 97A or 97B. As shown, an exemplary ray trace 96 for different locations on the screen can be mapped to positions on the lens and into the user's eye. The ray traces include a first portion 96A from the screen 98 to the optical element 94 and a second portion 96B including the reflection from the optical element 94 to the user's eye 97A. A third portion 96C is a projection or propagation of the trace through the display screen to a depth origin in which the displayed image is desired to be perceived by the user. In other words if the user was looking directly at the device screen and an object is desired to be perceived in three dimensional space beyond the screen, the ray would trace into the displayed space to the origin. Essentially, the propagation is where in dimensional space the object should be perceived by the user, and then the traces from through the screen, off of the optical element, and into the eye define where and how (such as in what proportion/distortion) to display the image on the screen.

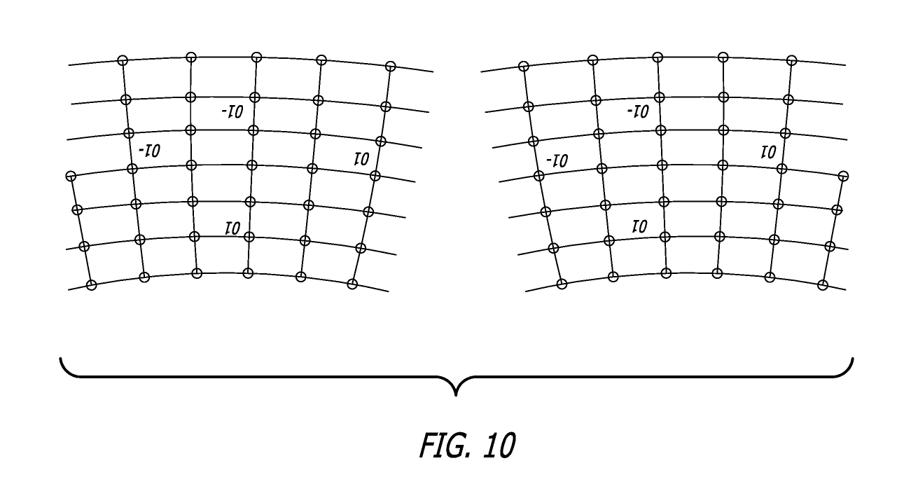

From the generated ray tracing, a counter-distortion map may be computed and used to influence, augment, modify, and/or create virtual objects to display on the screen to be projected to the user. Such displayed objects may be displayed with reduced distortion to improve the user's virtual experience. FIG. 10 illustrates an exemplary counter-distortion representation as driven by or defined by the ray tracings of FIG. 9, which were defined by the general attributes of the system and variable attributes entered through the user interface of FIG. 4.

In an exemplary embodiment, in order to account for distortions introduced by the imaging system, the system may be configured to apply a pre-distortion transform to the input image so that the perceived image is free or includes reduced distortion effects. An exemplary basic formula may be:

X(IPD,θ,φ)=XLookuptable(IPD,θ,φ)

Y(IPD,θ,φ)=YLookuptable(IPD,θ,φ)

where XLookupTable and YLookupTable are 3 dimensional arrays of display coordinates as a function of IPD, the azimuth (X, horizontal plane) angle θ, and the elevation (Y, vertical plane) angle φ.

Exemplary embodiments may therefore be used to directly and dynamically drive a counter-distortion model based on a specific ray-tracings as generated and defined by user entered, system (such as software or hardware) defined, or creator defined attributes (such as the general and variable attributes described herein). Exemplary embodiments may therefore define a method of altering, modifying, or creating a virtual object generated on a flat screen and reflected into the user's field of view by a lens system dynamically accounting for visual distortions created by the system components, the user, and/or relative positions and orientations thereof. Exemplary embodiments may be used to adjust model placement real-time, through variables directly available to a user through a user interface, such as that provided in FIG. 4. The model may be based directly on a ray-tracing algorithm, or an approximation of the ray-tracing algorithm, such as through counter-distortion mapping.

In an exemplary embodiment, the counter-distortion method uses a dynamic correlation directly on ray tracing without an equation approximation. This reduces approximations and ambiguities generated through the approximation process. This may also allow creators of virtual content to directly and immediately preview the results in the augmented/virtual system environment when a variable is adjusted, without having to separately compile and generate a predefined distortion map or equation for each change. This permits dynamic modifications to the hardware, or replacement of different device components on the fly.

Exemplary embodiments include an optical ray tracing innovation to create counter-distortion models. Exemplary embodiments may be used to adjust variables such as screen size and phone positioning on the fly. As such, exemplary embodiments may be used to greatly improve the ability to generate counter-distortion models for many different phone sizes or to accommodate new hardware designs on the fly verses going through the cumbersome process of recalculating a counter-distortion equation in third-party software for each design change.

Exemplary embodiments include an optical ray tracing innovation to define virtual object to overlay within a user's field of view within an augmented reality or virtual reality system. The optical ray tracing innovation may be used to determine an interpupilary distance that may be used to generate a stereoscopic rendering of the virtual object to be displayed on a screen. The interpupilary distance may be used to determine a relative position of the duplicated image to generate the three dimensional perception of the image.

Although embodiments of this invention have been fully described with reference to the accompanying drawings, it is to be noted that various changes and modifications will become apparent to those skilled in the art. Such changes and modifications are to be understood as being included within the scope of the present disclosure as defined by the appended claims. Specifically, exemplary components are described herein. Any combination of these components may be used in any combination. For example, any component, feature, step or part may be integrated, separated, sub-divided, removed, duplicated, added, or used in any combination with any other component, feature, step or part or itself and remain within the scope of the present disclosure. Embodiments are exemplary only, and provide an illustrative combination of features, but are not limited thereto. Exemplary embodiments may be used alone or in combination. For example, the system may be used to detect objects for determining a parameter of the system for determining a counter distortion mapping, or may simply be used to detect and object for gaze tracking or other purpose without the counter distortion mapping. The counter distortion mapping may be used without the detection or system calibration or may be used together.

Exemplary embodiments may including using eye tracking as a variable input into the system in order to reduce the computational complexity necessary to calculate a counter-distortion equation. In an exemplary embodiment, a polynomial approximation may be used for a method to counter distortion and render a virtual object to be displayed to a user. Exemplary embodiments permit certain fixed variables to be introduced into the calculation so that the counter distortion generated by the output of the polynomial approximation may be calculated in real time or on the fly during the rendering process.

When used in this specification and claims, the terms “comprises” and “comprising” and variations thereof mean that the specified features, steps or integers are included. The terms are not to be interpreted to exclude the presence of other features, steps or components. As used herein, “ray tracing” is not limited to the graphical application of rendering lighting or accounting for light within a scene or protection, or using actual or theoretic light paths to produce a two dimensional image. Exemplary embodiments include ray tracing being a theoretical or actual projection of a ray and tracing to or from a source or destination. For example, the ray trace may be used to create an accurate or approximate model for use in generating or analyzing virtual objects. Exemplary embodiments may use ray tracings having theoretical or actual projections of a light ray originating from a source or in reconstructing a source from an image for determining or calculating methods to create or define virtual objects to be perceived in a desired way and/or to counter distortion in the appearance in rendered or displayed virtual objects based on user characteristics, system attributes, other sources, or a combination thereof. The use of the term combination includes any combination of the identified items including any single item being used alone to all items being used in some combination and any permutation thereof.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realising the invention in diverse forms thereof.

The invention claimed is:

1. An optical ray tracing method and system for dynamically modeling reflections from an optical element, comprising, comprising:
defining a ray trace based on system parameters including a screen location, an optical component location.

2. The optical ray tracing method of claim 1, further comprising:
generating a display element based on the ray trace in real time.

3. The optical ray tracing method of claim 1, further comprising:
receiving an image reflected off of the optical element;
identifying a pupil location on the image;
using the ray trace to determine a world space location of the pupil identified on the image.

4. The optical ray tracing method of claim 3, further comprising using the world space location of the pupil to define a system parameter and update a counter distortion method used to generate a display object to be reflected off of the optical element.

5. The optical ray tracing method of claim 4, wherein the world space location of the pupil is used to determine an interpupilary distance of the user to calibrate images rendered stereoscopically.

6. The optical ray tracing method of claim 4, wherein the world space location of the pupil is used to determine a vertical offset of a headset positioned on a user's head.

7. The optical ray tracing method of claim 4, wherein the counter distortion method comprises using an updated ray tracing to generate a display image based on a desired perceived location of the virtual object, the on system parameters including the screen location, the optical component location, and an eye location determined from the world space location of the pupil.

8. The optical ray tracing method of claim 4, further comprising generating a virtual object to create a focal point for the user before receiving the image.

9. The optical ray tracing method of claim 8, further comprising receiving subsequent images reflected off of the optical element to track a user's eye position.

10. The optical ray tracing method of claim 8, further comprising receiving system parameters from a user through a user interface.

11. The optical ray tracing method of claim 1, further comprising using the ray trace in real time to adjust one or more variables of the system to create an individualized counter distortion model specific to a user.

12. An optical ray tracing method and system for dynamically modeling reflections from an optical element, comprising, comprising:
providing a headset configured to generate an image to be reflected off of the optical element and superimposed over a field of view of a user;
defining a ray trace based on system parameters including a location of a screen to generate the image, a location of the optical component.

13. The optical ray tracing method of claim 12, further comprising:
generating a display element rendered on the screen based on the ray trace in real time.

14. The optical ray tracing method of claim 12, further comprising:
providing non-transitory machine readable instructions that, when executed by a processor, is configured to:
receive a reflected image reflected off of the optical element;
identify a pupil location on the reflected image;
use the ray trace to determine a world space location of the pupil identified on the reflected image.

15. The optical ray tracing method of claim 14, wherein the non-transitory machine readable instructions are further configured to use the world space location of the pupil to create a counter distortion method for generating a display element rendered on the screen based on a ray trace using system parameters including the location of the screen to generate the image, the location of the optical component, and a position of a user's eye to perceive the image as determined based on the world space location of the pupil.
